(19) United States
(12) Patent Application Publication
(10) Pub. No.: US 2007/0162514 A1
(43) Pub. Date: Jul. 12, 2007

(54) Database sizing and diagnostic utility

(76) Inventors: Vincent Civetta, Morris Plains, NJ (US); Inna Brovman, Fort Lee, NJ (US); Steve Fabian, Sparta, NJ (US); Isabel Espina, Eaglewood, NJ (US)

Correspondence Address: THE HECKER LAW GROUP, 1925 CENTURY PARK EAST, SUITE 2300, LOS ANGELES, CA, 90067, US

(21) Appl. No.: 11/637,416

(22) Filed: Dec. 13, 2006

Related U.S. Application Data
(63) Continuation of application No. 10/648,051, filed on Aug. 26, 2003, now abandoned.
Application No. 10/648,051 is a continuation of application No. 09/513,654, filed on Feb. 25, 2000, now abandoned.

(51) Int. Cl. G06F 17/30

(52) U.S. Cl. 707/200

(57) ABSTRACT

A system for automated installation and maintenance of databases. One or more embodiments provide a user interface (or wizard) that obtains information from a user regarding aspects of the network environment and application data requirements. Using the information obtained from the user, a sizing process builds a database, or resizes an existing database, to efficiently match the needs of the user. An automated maintenance process self monitors, diagnoses, and fixes database problems, such as by rebuilding table keys and indexes. When the diagnostic cannot fix a problem, appropriate notification takes place. In one embodiment, the user information is processed using sizing formulas to obtain values for building the database. Database scripts and command files are generated which, when executed, build the appropriately configured database. Also, in accordance with the user information, scripts and command files may be generated that will implement a database backup process upon a user-specified schedule.

This application claims the benefit of U.S. Utility patent application Ser. No. 10/648,051 filed on Aug. 26, 2003 entitled “Sizing and Diagnostic Utility” which in turn is a continuation of U.S. Utility patent application Ser. No. 09/513,654 filed Feb. 25, 2000 entitled “Sizing and Diagnostic Utility,” which in turn claims priority of Provisional Patent Application No. ______ filed Feb. 26, 1999 entitled “Sizing and Diagnostic Utility” the specifications of which are herein incorporated in their totality by reference.

Portions of the disclosure of this patent document contain material that is subject to copyright protection. The copyright owner has no objection to the facsimile reproduction by anyone of the patent document or the patent disclosure as it appears in the Patent and Trademark Office file on record, but otherwise reserves all copyright rights whatsoever.

### BACKGROUND OF INVENTION

1. Field of Invention

This invention relates to the field of databases.

2. Background Art

Installing and maintaining a database is a complex and time consuming task. Typically, a specially trained and/or certified person or team is required for installing and setting up a database. Maintaining the database during operation often requires that a service team be contacted to provide support.

Another problem associated with databases is that the database and the application using the database are often independently designed and configured, leading to fragmentation and decreased performance. Further, over time, the data residing in the database changes, as well as the relationships between the data. This too causes fragmentation, even in databases that may have been well-configured initially to suit the original data needs of the user.

Some databases, such as the Oracle™ database, are organized into “tablespaces.” Tablespaces are physical allocations of space that hold related objects such as tables or indexes. Tables and indexes are created in specific tablespaces. These tables and indexes are created with an initial allocation within a tablespace, which is referred to as an “extent.” If a table or index runs out of space in the initial extent, a further pre-defined extent may be allocated. New extents are often allocated from contiguous free space within a tablespace. As a tablespace becomes fragmented, the tablespace's free space can be left in such small blocks that the free space is virtually unusable. Also, when tables or indexes have too many extents, the database's performance degrades. Multiple extents require more physical I/O operations to accomplish a query.

A database solution is desired that minimizes the need for specially trained personnel for configuring and maintaining a database, and addresses the problems associated with database fragmentation, both initially and over time.

### SUMMARY OF THE INVENTION

The invention is a system for automated installation and maintenance of databases. One or more embodiments provide a user interface (or wizard) that obtains information from a user regarding aspects of the network environment and application data requirements. Using the information obtained from the user, a sizing process builds a database, or resizes an existing database, to efficiently match the needs of the user. An automated maintenance process self monitors, diagnoses, and fixes database problems, such as by rebuilding table keys and indexes. When the diagnostic cannot fix a problem, appropriate notification takes place.

In one embodiment, the user information is processed using sizing formulas to obtain values for building the database. Database scripts and command files are generated which, when executed, build the appropriately configured database. Also, in accordance with the user information, scripts and command files may be generated that will implement a database backup process upon a user-specified schedule.

### BRIEF DESCRIPTION OF THE DRAWINGS

FIG. 1 is a block diagram of a general-purpose computer upon which an embodiment of the invention may be implemented.

FIG. 2 is a block diagram of an embodiment of the invention.

FIG. 3 is a flow diagram of a sizing process in accordance with an embodiment of the invention.

FIG. 4 is a flow diagram of a maintenance process in accordance with an embodiment of the invention.

FIGS. 5A-5C are flow diagrams of steps within the process of FIG. 4.

### DETAILED DESCRIPTION OF THE INVENTION

In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

### Embodiment of General-Purpose Computer Environment

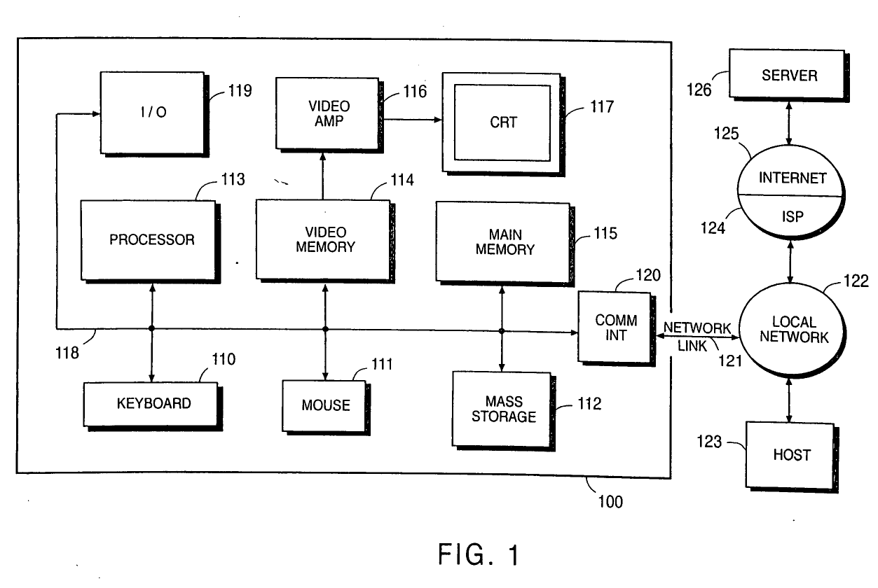

An embodiment of the invention can be implemented as computer software in the form of computer readable program code executed on a general-purpose computer such as computer 100 illustrated in FIG. 1. A keyboard 110 and mouse 111 are coupled to a bi-directional system bus 118. The keyboard and mouse are for introducing user input to the computer system and communicating that user input to central processing unit (CPU) 113. Other suitable input devices may be used in addition to, or in place of, the mouse 111 and keyboard 110. I/O (input/output) unit 119 coupled to bi-directional system bus 118 represents such I/O elements as a printer, A/V (audio/video) I/O, etc.

Computer 100 includes a video memory 114, main memory 115 and mass storage 112, all coupled to bi-directional system bus 118 along with keyboard 110, mouse 111 and CPU 113. The mass storage 112 may include both fixed and removable media, such as magnetic, optical or magnetic optical storage systems or any other available mass storage technology. Bus 118 may contain, for example, thirty-two address lines for addressing video memory 114 or main memory 115. The system bus 118 also includes, for example, a 32-bit data bus for transferring data between and among the components, such as CPU 113, main memory 115, video memory 114 and mass storage 112. Alternatively, multiplex data/address lines may be used instead of separate data and address lines.

In one embodiment of the invention, the CPU 113 is a microprocessor manufactured by Motorola, such as the 680×0 processor or a microprocessor manufactured by Intel, such as the 80×86, or Pentium processor, or a SPARC microprocessor from Sun Microsystems. However, any other suitable microprocessor or microcomputer may be utilized. Main memory 115 is comprised of dynamic random access memory (DRAM). Video memory 114 is a dual-ported video random access memory. One port of the video memory 114 is coupled to video amplifier 116. The video amplifier 116 is used to drive the cathode ray tube (CRT) raster monitor 117. Video amplifier 116 is well known in the art and may be implemented by any suitable apparatus. This circuitry converts pixel data stored in video memory 114 to a raster signal suitable for use by monitor 117. Monitor 117 is a type of monitor suitable for displaying graphic images.

Computer 100 may also include a communication interface 120 coupled to bus 118. Communication interface 120 provides a two-way data communication coupling via a network link 121 to a local network 122. For example, if communication interface 120 is an integrated services digital network (ISDN) card or a modem, communication interface 120 provides a data communication connection to the corresponding type of telephone line, which comprises part of network link 121. If communication interface 120 is a local area network (LAN) card, communication interface 120 provides a data communication connection via network link 121 to a compatible LAN. Wireless links are also possible. In any such implementation, communication interface 120 sends and receives electrical, electromagnetic or optical signals which carry digital data streams representing various types of information.

Network link 121 typically provides data communication through one or more networks to other data devices. For example, network link 121 may provide a connection through local network 122 to host computer 123 or to data equipment operated by an Internet Service Provider (ISP) 124. ISP 124 in turn provides data communication services through the world wide packet data communication network now commonly referred to as the “Internet” 125. Local network 122 and Internet 125 both use electrical, electromagnetic or optical signals which carry digital data streams. The signals through the various networks and the signals on network link 121 and through communication interface 120, which carry the digital data to and from computer 100, are exemplary forms of carrier waves transporting the information.

Computer 100 can send messages and receive data, including program code, through the network(s), network link 121, and communication interface 120. In the Internet example, server 126 might transmit a requested code for an application program through Internet 125, ISP 124, local network 122 and communication interface 120.

The received code may be executed by CPU 113 as it is received, and/or stored in mass storage 112, or other non-volatile storage for later execution. In this manner, computer 100 may obtain application code in the form of a carrier wave.

The computer systems described above are for purposes of example only. An embodiment of the invention may be implemented in any type of computer system or programming or processing environment.

### Embodiment of Database Sizing and Diagnostic Utility

Embodiments of the invention are directed at building and maintaining a database in which the sizing allocations conform to the needs of the user application that is using the database. The initial configuration of the database is performed based on user-provided information about the networking environment and assumptions about the application needs of the user. The user assumptions may become less accurate over time, in which case, an embodiment of the invention may be used to obtain new assumptions from the user regarding application needs. Those new assumptions are then used to resize the database.

As an example, an Oracle database may be used to implement a payroll system application. In such a case, user information is obtained in the form of assumptions about the projected number of employees in the company, the number and types of payroll items that apply to the average employee, etc. The database sizing and diagnostic utility is configured with formulas for converting those payroll assumptions into table parameters that are then used to size the database.

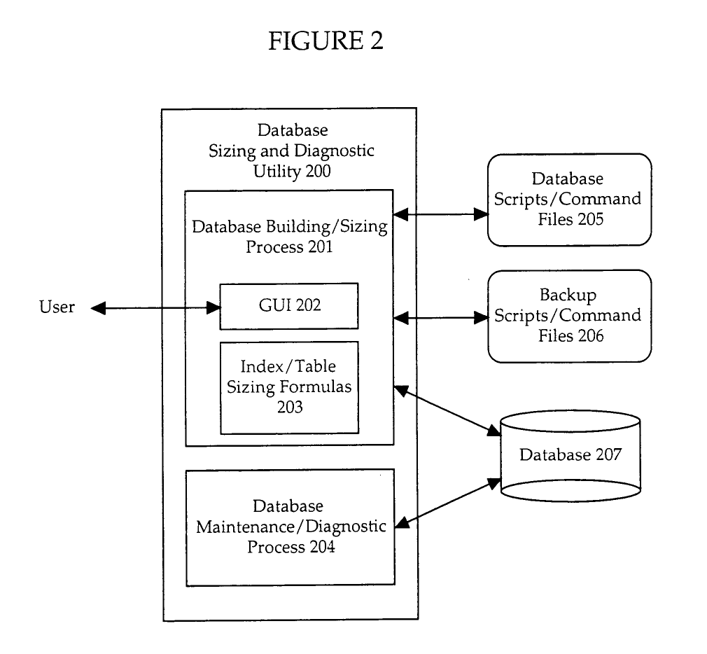

An embodiment of the invention is illustrated in FIG. 2. As shown, a database sizing and diagnostic utility 200 comprises a database building/sizing process 201 and a database maintenance/diagnostic process 204. Within database building/sizing process 201 are a graphic user interface (GUI) 202 (also referred to herein as a “wizard”) and index/table sizing formulas 203.

In one embodiment, GUI 202 presents a sequence of panels for receiving user input. It will be obvious, however, that the invention is not limited to those GUI mechanisms, and that any form of user interface may be employed (e.g., an audio interface). GUI 202 is used to ask questions of the user and to obtain user information in return. The user information comprises information about the networking environment, assumptions about the application-specific needs of the user, and user preferences for database backup operations.

The index/table sizing formulas 203 are used to transform the user information into database sizing parameters that are incorporated into database scripts and command files 205 for building and sizing (or resizing) the database 207. Backup scripts and command files 206 are generated by database building and sizing process 201 from the user-specified backup preferences.

Database maintenance/diagnostic process 204 executes on a periodic basis to evaluate the performance of the database (though a user may also manually prompt the database maintenance/diagnostic process 204 to execute). Entries made to a logfile may serve as an indicator to a user that it may be appropriate to resize the database 207. Problems with tables and indexes which are identified by the database maintenance/diagnostic process 204 are automatically fixed when possible.

Database Building/Sizing Process

The database building and sizing process 203 is used by the user to optionally install and configure the database engine on their network server, and to build a pre-sized database for a given database application. The advantage of presizing the database correctly is a reduction in tablespace fragmentation and increased performance. Presizing the database, along with the automated database maintenance/diagnostic process 204, permit a user to install a database application without requiring an on-site certified database specialist to manage the database.

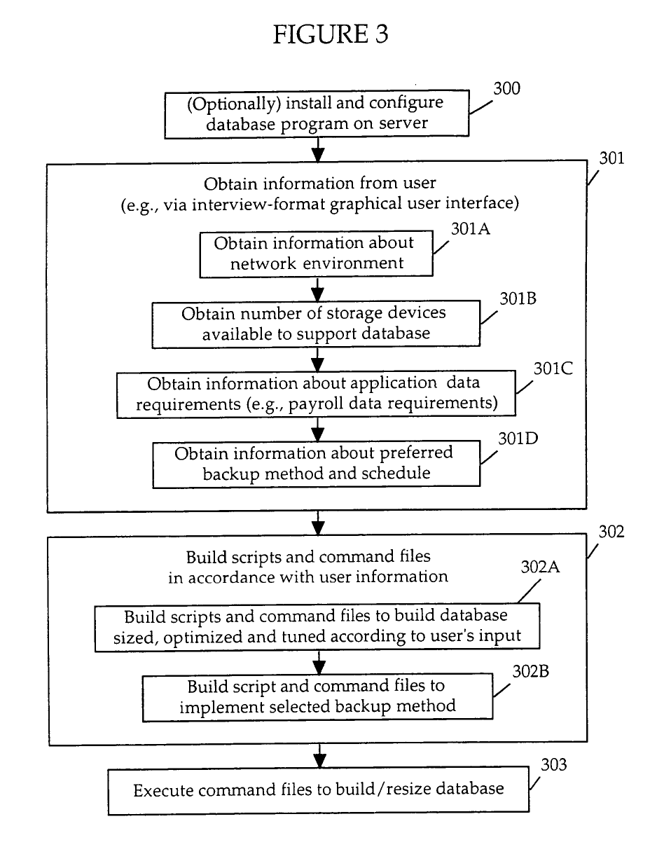

FIG. 3 is a flow diagram of the database building/sizing process 201 in accordance with an embodiment of the invention. In step 300, process 201 optionally installs and configures the database engine on the user's server machine. If this is a resizing operation or if the database engine is already installed, step 300 is skipped. In step 301, the database building/sizing process 201 collects information from the user via GUI 202 (e.g., in interview format).

Step 301 is subdivided into component steps 301A-301B. In step 301A, the user information obtained includes information regarding the user's network environment (number of users and amount of RAM, for instance). In step 301B, process 201 obtains information from the user regarding how many drives the user wants the database to span. In step 301C, the user information obtained concerns the data requirements of the database application, e.g., for a payroll application, the user's payroll data requirements (number of employees, number of company codes, and amount of history to keep online, for instance). In step 301D, GUI 202 obtains the user's preferences for database backup operations, including the backup mode (if more than one mode is available) and the backup schedule.

In step 302, the database building/sizing process 201 generates a series of instructions, for example SQL scripts and Windows NT command files, in accordance with the user information obtained in step 301. Specifically, in step 302A, instructions are generated to physically create a database that will sufficiently house the user's data, and that will be optimized and tuned to perform as well as possible, e.g., based on the network environment information and other user information. In step 302B, instructions are generated to implement the specified periodic backup operation. In step 303, database building/sizing process 201 executes the command files to physically build the database.

In one embodiment of the invention, database building/sizing process 201 and its constituent GUI 202 are implemented as a “wizard” application. The user is presented with a sequence of panels from which the user information of step 301 is obtained. One possible implementation of such a wizard application is described in Appendix A, with corresponding pseudo-code, under the heading “dbsizer.exe: Oracle Sizing Wizard.” A database utility program for performing certain database procedures with command line parameters is described in Appendix A under the heading of “brunner.exe: Database Utility Program,” with accompanying pseudo-code and source code.

Database Maintenance/Diagnostic Process

The database maintenance/diagnostic process 204 is an unattended database diagnostic and auto-maintenance utility used by the user to perform the following database procedures:

1. check the database for tablespace fragmentation

2. check the tablespaces for available free space

3. check the hard drives for available free space

4. fix any problems that can be fixed automatically without risk

The database maintenance/diagnostic process 204 is scheduled to run at intervals, e.g., once per week, and terminates automatically upon completion. Process messages and errors are written to a logfile for user reference.

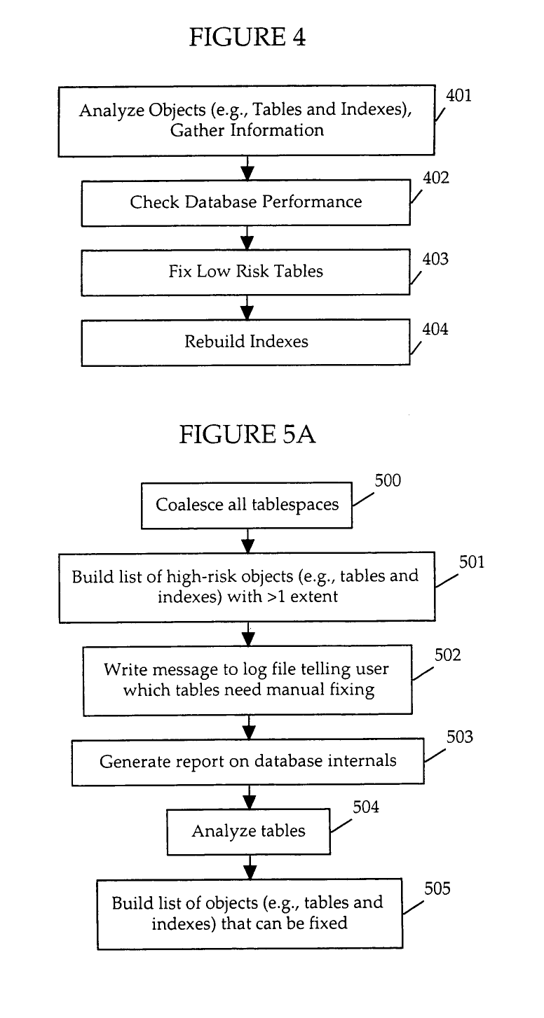

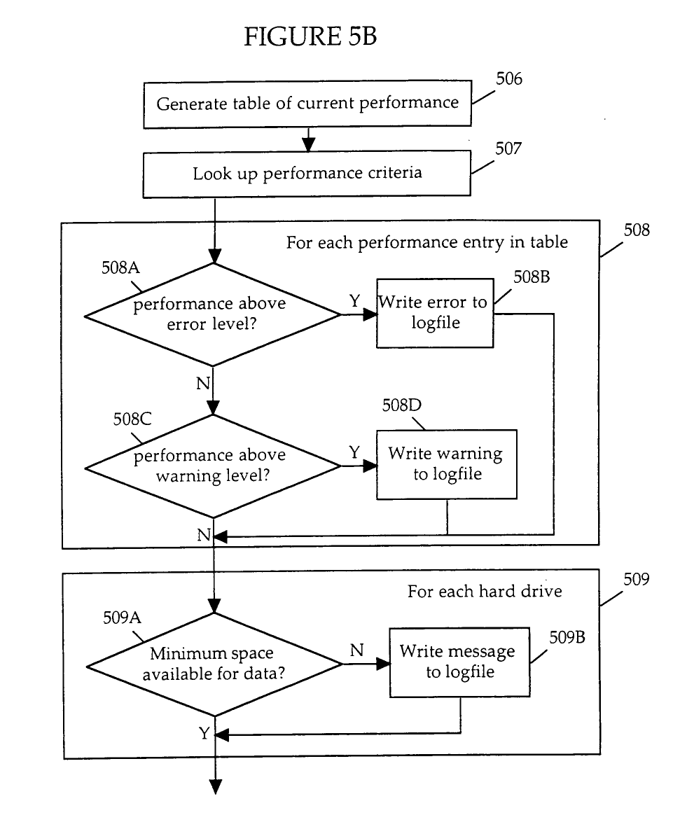

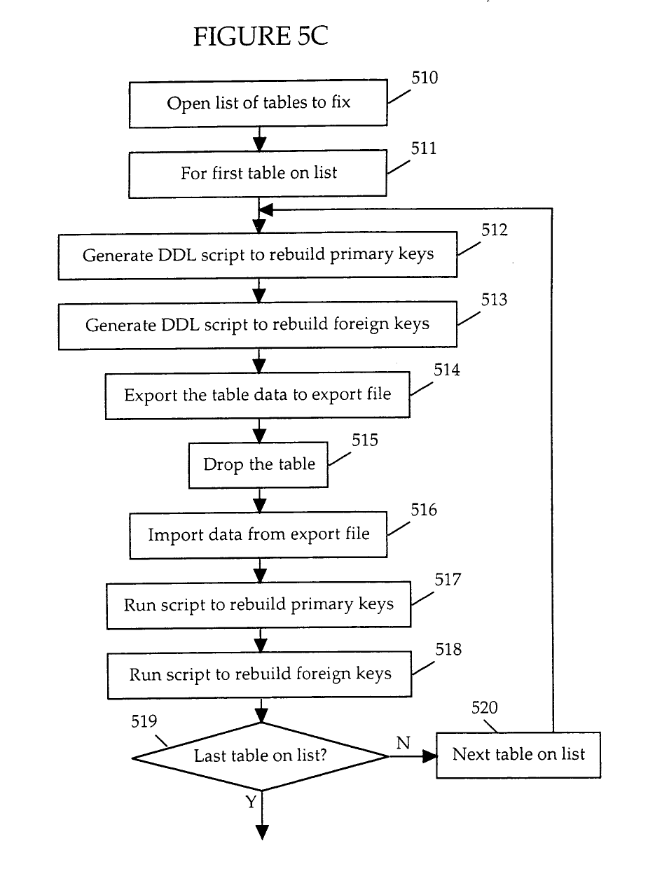

The general flow of the maintenance/diagnostic process is illustrated in FIG. 4. In step 401, all objects (e.g., tables and indexes) are analyzed, and information is gathered regarding those objects that can be fixed automatically and those objects that require manual fixing. In step 402, the database performance is evaluated, with problem areas noted in the logfile. In step 403, those tables that were designated for automatic fixing in step 401 are fixed. In step 404, indexes are rebuilt where necessary. Steps 401-403 are described in more detail below with reference to FIGS. 5A-5C, respectively.

FIG. 5A is directed to table analysis and the gathering of information about the database. In step 500, the database maintenance/diagnostic process 204 coalesces all tablespaces, and, in step 501, builds a list of all high-risk objects with extents greater than one. Objects are considered high-risk if their extents are numerous enough that an automatic fixing operation could compromise their integrity. These high-risk objects are listed in the logfile, in step 502, as objects that will require manual fixing. In step 503, a report is generated on the database internals. In step 504, all tables are analyzed, and in step 505, a list is made of those objects that should be automatically fixed by the database maintenance/diagnostic process.

FIG. 5B illustrates steps for performing database performance analysis. In step 506, a table is generated that contains entries for database performance values in different categories. In step 507, performance criteria are obtained that specify, for example, error levels and warning levels for each performance category. Step 508, comprising steps 508A-508D, is performed for each entry in the performance table generated in step 506. In step 508A, the performance value for one entry in the table is compared with the corresponding error level. If the performance value is above the specified error level, an error message is written to the logfile in step 508B, and the process continues at step 509. If, in step 508A, the performance value is not above the error level, then the performance value is compared with the warning level in step 508C. If the performance value is above the error level, a warning message is written to the logfile in step 508D before proceeding to step 509. If the performance value is not above the warning level in step 508C, the process continues at step 509.

Step 509, comprising steps 509A-509B, is performed for each hard drive upon which the database is spread. In step 509A, the free space of the hard drive is compared with a minimum space threshold value needed to support the database. If the free space available does not meet the minimum space threshold value, a warning message is written to the logfile in step 509B.

FIG. 5C illustrates one method for fixing tables in accordance with an embodiment of the invention. In step 510, the database maintenance/diagnostic process 204 opens the list of tables that can be automatically fixed. In step 511, the first table listed is selected for fixing. In step 512, a DDL script is generated that will rebuild the primary keys of the table, and, in step 513, a DDL script is similarly generated to rebuild the table's foreign keys.

In step 514, the table data is exported to an export file and, in step 515, the table is dropped. In step 516, the table data in the export file is imported back in. In steps 517 and 518, respectively, the primary key and foreign key rebuild scripts are run to fix the table. In step 519, if the current table is not the last table on the list, the next table is selected and the process continues at step 512; otherwise, the process continues in step 404 of FIG. 4.

One possible implementation of database maintenance/diagnostic process 204 is described in Appendix A, with corresponding pseudo-code and source code, under the heading “hwb.exe: Health and Well-Being Utility.”

Thus, a database sizing and diagnostic utility has been described in conjunction with one or more embodiments. The invention is defined by the claims and their full scope of equivalents.

Chapter 1

### APPENDIX A

dbsizer.exe

Oracle Sizing Wizard

Overview

The dbsizer utility is used by the client to (optionally) install and configure the Oracle Database engine on their Network Server, and to build a pre-sized ADP PC/Payroll for Windows database. The advantage of pre-sizing the database correctly is a reduction in tablespace fragmentation and increased performance. This process of pre-sizing the database along with the Health-and-Well Being utility (hwb.exe) allows ADP to install an Oracle based application without requiring an Oracle DBA on-site to manage the database.

Process Overview

The Oracle Sizing Wizard (‘the wizard’) collects information from the user regarding their network environment (# users, amount of RAM, etc), their payroll data requirements (# of employees, # of company codes, amount of history to keep online, etc) and generates a series of SQL scripts and NT command files to physically create a database that will sufficiently house the client's data and perform as well as possible. The steps break down as follows;
1. Install and Configure Oracle on the client's Server (if requested, this is an optional step).
2. Gather information about the user's network environment.
3. Determine how many drives the user want to spread the Oracle database over (the more the better).
4. Gather information about the client's company and their payroll data requirements.
5. Ask the user which backup method they would like to use to backup their PCPW database (The wizard can install three different types of automated backups, as well as support a custom one supplied by the client)
6. Ask the user when they would like the backup to take place (schedule)
7. Build the scripts and command files to build the database sized according to the user's input, and build script and command files to implement the backup method chosen by the user.
8. Execute the command files to physically build the database,
   Architectural Overview

The wizard is a Visual Basic 5.0 application that looks like a standard wizard. It appears to be one window that asks a series of questions and performs a task at the end when all necessary information has been gathered. It can be thought of as a ‘interview-style’ application.

Technically, each panel is a separate window and as the user presses the Back or Next button, to display the previous or next panel, the application hides the current window and displays the next one.

Control information is stored in an Access97 format database named default.mdb There are a number of tables in this database that are used by the wizard.

| Table Name | Description/Usage |
|---|---|
| DBMisc | Miscellaneous information. Backup Method |
| | and Schedule |
| DBOptions | Items that are used to create the |
| | INITPCPW.ORA file. These items control the |
| | configuration of the Oracle database engine |
| ExistingTablespaces | Tablespaces and current size. Used by the |
| | wizard in resize mode to resize existing |
| | tablespaces. |
| FileLocations | Location of Oracle components and the |
| | PCPW admin folder |
| Indexes | Index sizing formulas and which tablespace |
| | each index is associated with |
| OracleComponents | For each Oracle Version supported, which |
| | components are to be installed by the |
| | automatic response script. |
| OracleVersions | Supported Oracle Versions |
| RangedObjects | Ranged formulas. These formulas override |
| | the formulas in Indexes, Tables and |
| | DBOptions. They allow multiple formulas to |
| | be defined for different ranges of NUMBER |
| | OF EMPLOYEES |
| Tables | Table sizing formulas and which tablespace |
| | each table is associated with |
| Tablespace | List of tablespaces |
| VariablesNNNNNN | There is one table for each Language |
| | supported. The NNNNNN value must match |
| | the Language id stored in the OS registry. |
| | These tables contain the prompts for |
| | Network Enviroment questions and Company |
| | Information questions. |

Pseduo-Code

‘Panel 1 -The Welcome panel (frmPage1)
get the OS language from the registry
initialize program variables and counters
search for the ADPSETUP.INI file

for each addressable drive

look in \ADP\PCPW.DSK\DISK1

if not found

for each addressable drive

search all folders for ADPSETUP.INI

end if

if not found

display error message
exit

end if
retrieve the Server's IP address from the ADPSETUP.INI file
retrieve the location of the Migrate folder from the
ADPSETUP.INI file
‘Navigation
‘Back is always disabled
‘Next takes you to Panel 2 - Install Oracle (frmPage2)
‘Panel 2 -Install Oracle (frmPage2)
open the default database (default.mdb)
if it's not found in the current folder

pop a dialog so the user can tell you where it is.

end if
If we're running in Design mode

Display the Load Configuration push button

end if
‘Navigation
‘Back takes you to Panel 1 - Welcome (frmPage 1)
‘Next has the following processing logic

if the user wants the wizard to install Oracle

if Oracle is RUNNING (check for active service)

display error message
exit

end if
pop a dialog box to get the
Server IP address (default from

ADPSETUP.INI)

If the user changed the IP address

Write the new value to
the ADPSETUP.INI file

End if
Search for the Oracle CD
Run the Oracle installation program
with a scripted response file
If it fails

Exit

endif

End if
Search for an existing PCPW database
If found

Ask the user if they want to
resize the existing database
If they say no

Exit

End if
If they say yes

Make sure the instance if
running and the database is up

End if

End if
If we installed Oracle

Display Panel 4 - Network
Environment (frmNetworkEnv)

Else

Display Panel 3 - Where is Oracle (frmPage3)

End if

‘Panel 3 - Where is Oracle (frmPage3)
retrieve the default locations for the Oracle files
‘Navigation
‘Back takes you to Panel 2 - Install Oracle (frmPage2)
‘Next has the following processing logic

if we're not in development mode

verify the locations entered by the user

BIN should contain ORADIM73.EXE
RDBMS should contain CATALOG.SQL

End if
Make sure the version of Oracle is 7.3.4 . . .
Save the new locations as the defaults
If we're in RESIZE mode

Display Panel 6 - Company Information (frmPage5)

Else

Display Panel 4 - Network
Environment (frmNetworkEnv)

End if

‘Panel 4 - Network Environment (frmNetworkEnv)
load all Network questions from the database into the grid
‘Navigation
‘Back has the following processing logic

if the wizard installed Oracle

Display Panel 2 - Install Oracle (frmPage2)

Else

Display Panel 3 - Where is Oracle (frmPage3)

end if

‘Next has the following processing logic

if we're in DEVELOPMENT mode

Display Database Options (frmPage4)
‘NOTE: This is a DEVELOPMENT
mode ONLY panel

Else

Display Panel 5 - Drives (frmDrives)

end if

‘Panel 5 - Drives (frmDrives)
load combo boxes

for each addressable drive

make sure we can write to it
if we can

determine amount of free space
add it to all 9 list boxes

end if

next drive
sort all 9 list boxes by free space
add <None> item to the top of each list box
for each list box

select the drive with the most space free
that hasn't been selected yet

next

‘Navigation
‘Back has the following processing logic

if we're in DEVELOPMENT mode

Display Database Options (frmPage4)
‘NOTE: This is a DEVELOPMENT
mode ONLY panel

Else

Display Panel 4 - Network
Environment (frmNetworkEnv)

end if

‘Next has the following processing logic

Display Panel 6 - Company Information (frmPage5)

‘Panel 6 - Company Information (frmPage5)
load all company questions from the database into the grid
‘Navigation
‘Back has the following processing logic

if we're in RESIZE mode

if the wizard installed Oracle

Display Panel 2 - Install Oracle (frmPage2)

Else

Display Panel 3 - Where is
Oracle (frmPage3)

end if

else

Display Panel

end if

‘Next has the following processing logic

if we're in RESIZE mode

Display Panel 9b - Resize (frmPage9)

Else

Display Panel 7 - Backup Information (frmPage6)

end if

‘Panel 7 - Backup Information (frmPage6)
display editable form with current values from default.mdb
‘Navigation
‘Back has the following processing logic

Display Panel 6 - Company Information (frmPage5)

‘Next has the following processing logic

Display Panel 8 - Backup Schedule (frmPage7)

‘Panel 8 - Backup Schedule (frmPage7)
display editable form with current values from default.mdb
if we're in DEVELOPMENT mode

display the “Save Configuration” push button

end if
‘Navigation
‘Back has the following processing logic

Display Panel 7 - Backup Information (frmPage6)

‘Next has the following processing logic

Based upon the number of drives selected

Set the target drive for each database element
‘See the functional spec for more information

Display Panel 9a - Please wait,
Database Creation Scripts (frmPage8)

‘Panel 9a - Please wait . Database Creation Scripts (frmPage8)
‘Create the scripts and command files to build the database
‘a progress bar is displayed during this panel
store all the user id's and encoded passwords
in the NT Server's registry
make sure all necessary folders exist
if any do not

create them

end if
make sure there's at least 1 MEG free for scripts on the 1^{st} drive
create the scripts and command files

create the INITPCPW.ORA file
create the SETUPDB.SQL file
create the TABPCPW.SQL file

take the TABXXX.TML file
merge the table sizing formulas from default.mdb

create the IDXPCPW.SQL file

take the IDXXXX.TML file
merge the index sizing formulas from default.mdb

create the backup scripts and command files
create the AT schedule entry
copy all required files from the DBSIZER folder
to the ADMIN folder
create the command files to create the database
backup the PCPW registry entries to a PCPW.REG
file in the ADMIN folder

‘Navigation
‘the user has no choice, as soon as all files are created
Display Panel 10 - Next Steps (frmNextSteps)
‘Panel 9b - Please wait, Database Resize Scripts (frmPage9)
‘Create the scripts and command files to resize the database
‘a progress bar is displayed during this panel
create the scripts and command files
calculate size needed for each table
calculate size needed for each index
rollup the sizes into the tablespaces

for each tablespace

determine the current size
compare it to the new size
if the new size if bigger

calculate the difference
find a drive which can handle the difference

check the drive the current
tablespace is on
if it fits, use it
if not

check other drives that
are host PCPW data

if it fits and
passes the
neighbor rules
‘Neighbor rule
state which
tablespaces

can

‘live on the
same drives
as others
‘see the
functional
spec for more

information

use it

end if
if we found a new home,

build a script to create
a new datafile for the

tablespace

else

pop a dialog and ask
the user for a new drive
if they give one

make sure it
has enough
room
if so

build
the
script

else

exit

end if

end if

end if

end if

next tablespace

‘Navigation
‘the user has no choice, as soon as all files are created
Display Panel 10 - Next Steps (frmNextSteps)
‘Panel 10 - Next Steps (frmNextStepS)
display a summary of the size of the database to be created or res~zed
‘Navigation
‘Create Database button pushed
If in RESIZE mode

Display Panel 11b - Database Resize in Process (frmResize)

else

Display Panel 11a - Database Creation in Process (frmCreation)

‘Cancel
warn the user that if they cancel, they have to start over
if they say okay

delete scripts and command files
exit

end if
‘Panel 11a - Database Creation in Process (frmCreation)
Display a checklist of steps to create the database
Execute the command file createdb.cmd
As each step completes in createdb.cmd

A ‘checkpoint’ file is created (step1.chk, step2.chk...step9.chk)

As each checkpoint file is created

Display a checkmark on the panel next
to the step just completed.

When all 9 steps are complete.

Cleanup scripts and command files
exit

‘Panel 11b - Database Resizing in Process (frmResize)
Display a checklist of steps to resize the database
Execute the command file resizedb.cmd
As each step completes in resizedb.cmd

A ‘checkpoint’ file is created (step1.chk)

As each checkpoint file is created

Display a checkmark on the panel
next to the step just completed.

When all steps are complete.

Cleanup scripts and command files
exit

Command Line Parameters

The following command line parameters are recognized by the brunner utility

/D

Runs dbsizer in development mode. Development mode allows the user to modify the sizing formulas for tables and indexes as well as the Oracle engine parameters that are written to the INITPCPW.ORA file. In addition, the user is allowed to load and save multiple configuration files. (Note: When running in regular mode, only the configuration file default.mdb will be used.)

/DEBUG

Runs dbsizer in debug mode. Normally as the Oracle utilities are executed, the command window which executes them is hidden from the user completely, including the task bar. If you run the wizard in debug mode, the command windows will only be minimized instead of hidden giving you the ability to see the command lines and any output from the utilities being executed.

NT Server—Registry Entries

When the Oracle sizing wizard is run by the client to create their database, a number of entries are written to the NT Server's system registry. The following entries are created by dbsizer during database creation.

KEYS USED BY THE HEALTH and WELL-BEING UTILITY (HWB)
[HKEY_CURRENT_USER\Software\VB and
VBA Program Settings\PCPWOra\LogFiles]
“Age”=“90”
[HKEY_CURRENT_USER\Software\VB and
VBA Program Settings\PCPWOra\Extents]
“Number”=“1”
[HKEY_CURRENT_USER\Software\VB and
VBA Program Settings\PCPWOra\HWB]
“Tables”=“1”
“Performance”=“0”
“Use Note of the Day”=“True”

The Age key controls how long messages are kept in the brunner.log file. This value is set during install and there is no method for changing this value with the exception of using the regedit program supplied as part of the NT Server Operating System.

The Number key controls how many extents are required before HWB will attempt to automatically fix the table or index.

The last three are used by HWB to control whether or not Tables and/or Performance statistics are checked during execution. By default, tables are checked, performance is not. The Note of the Day entry determines whether or not HWB will report fatal errors back to the user via the T_NOTE_OF_THE_DAY table.

[HKEY_CURRENT_USER\Software\VB and
VBA Program settings\PCPWOra\Keys]
“PCPAYSYS”=“_=^{˜}ê_{—}^{˜}Uh”
“INTERNAL”=“Ü\dot{a} Y}_fÖ”
“MaintKey”=“_=^{˜}ê_{—}^{˜}Uh”
“MIGRATE”=“re_ëY=Á ”
“SUPEROP”=“_æÓ¦ _ ^{a}”
“REPORTS”=“,u⅜ y̅_\hat{ }•ƒ”
“Default”=“_=^{˜}ê_{—}^{˜}Uh”
“SYS”=“¹-_C_L(α”
“SYSTEM”=“í3TN a̅YIp”

These keys represent the user id's and passwords which can be part of a template (.brt file. In order to use one of the user id/password combinations, the user id must be surrounded by %'s in the .brt file. For example, to use the SrvMgr23 utility to run a SQL file named dothis.sql and use the INTERNAL id and password, the following line would be in the dothis.brt file.

connect INTERNAL / %INTERNAL%
. . . some sql code here

At run time, brunner will retrieve the value for the INTERNAL key from the registry, decode the key value and write the following to the tempn.sql file in the c:\temp folder

connect INTERNAL / THEPASSWORD
. . . some sql code here
[HKEY_CURRENT_USER\Software\VB and
VBA Program Settings\PCPWOra\Files]
“Home”=“C:\\ORANT\\BIN”
“Maintenance”=“C:\\ORADATA\\PCPW\\admin\\maint”
“Admin”=“C:\\ORADATA\\PCPW\\ADMIN”
“Backup”=“ ”

These settings let the Wizard, BRunner and HWB know where to find other files that they may need during execution

Chapter 1

brunner.exe

Database Utility Program

Overview

The brunner utility is used by the client to perform the following database procedures
1. Manually bring the database up in normal or restricted mode
2. Manually shut the database down
3. Manually perform the database backup as established by the sizing wizard during database creation.
4. Manually reschedule the automated backup process as established by the sizing wizard during database creation.

The brunner utility is also used to perform some of these functions during the database creation process. In this mode, brunner is executed with command line parameters so that user intervention is not required. (See the dbsizer.exe detailed design spec, dbsizer.doc, for more information on the usage of brunner during database creation)

In general, regardless of which task brunner is performing the process is as follows;
1. check to see if the database is up or down.
2. if the function is passed on the command line, perform it . . . if not, display a menu of available functions based upon the current state of the database and let the user select which function to perform.
3. create a command file to perform the requested function (if SQL based, create the SQL file to perform the function and a command file to execute the SQL using the SrvMgr23 utility supplied by Oracle)
4. delete the command file and the SQL file
5. exit

Some of the functions use pre-defined command file templates called .BRT files. These files are identical to the command files or SQL files that will be used to perform the various brunner functions, however they require that an Oracle password be supplied on the command line to the Oracle utility that is being executed. In order to hide the password, placeholders are used in the .BRT files and brunner will perform the following steps when executing a secure batch file.
1. open the batch template file (.brt)
2. create a temporary batch file (tempn.cmd) in the c:\temp folder
3. read each line from the template file
4. if the line contains a password placeholder, lookup the password in the system registry, decode it and place it in the temporary file, otherwise write the line as is to the temporary file.
5. execute the temporary file
6. delete the temporary file
7. exit

During execution, brunner maintains a log file which contains information about each run. Dates and times are written to the log along with the function which was requested and any errors that occurred during execution.

At any given time, the log file contains entries for the past 90 days. Log entries older than 90 days are rolled off the log. The number of days (90 is the default) worth of messages kept in the log file can be altered by changing an entry in the system registry. See the section on Registry entries for more information.

Psedo-Code

Following is pseudo-code for the bunner utility program.

center the main form
if the command line contains “/MSG:”

take the text that follows and display it on the
screen in a message box
exit

end if
get the location of the Oracle binaries from the registry
get the language setting from the registry
if the command line is NOT/SCHEDULE then

check to see if the database is up or down (run checkdb.brt)
if we can't determine the status of the database

log the error
exit

end if
display the appropriate bitmap on the form so the user
knows the db status

end if
if no command line was specified

display a menu of choices to the user

end if
write the start time and request to the log file
branch to the requested process
‘backup branch
if the database is down, we can't perform the backup, so...

log the error
exit

end if
if we're using the copy or compress method

make sure there's enough disk space on the destination drive
if not

log the error
exit

end if
if the destination folder does not exist

create it

end if

end if
bookmark the Oracle alter log
perform the backup (run backup.brt which is created by
dbsizer during install)
check the Oracle alter log for Oracle errors
if any errors

write them to the brunner log
write a Note of the Day entry to the database

end if
close the log file
exit
‘start the database (normal) branch
bookmark the Oracle alert log
start the database (run startdb.brt)
check the Oracle alert log for errors
if any errors

write them to the brunner log

end if
close the log file
exit
‘stop the database branch
‘parameter: RunStats
if RunStats is true

update database statistics (run doperf.sql)

end if
bookmark the Oracle alert log
stop the database (run stopdb.brt)
check the Oracle alert log for errors
if any errors

write them to the brunner log

end if
close the log file
exit
‘re-start the database branch
‘difference between start and restart, is that restart clears any
‘Note of the Day entry in the database. This is done in the
‘restart.brt template file.
bookmark the Oracle alert log
start the database (run restartdb.brt)
check the Oracle alert log for errors
if any errors

write them to the brunner log

end if
close the log file
exit
‘schedule branch
check to see if there's already a call to BRUNNER with
/SCHEDULE in the AT list
if not

run schdback.cmd to schedule the backup process

end if
exit
‘start the database (restricted) branch
bookmark the Oracle alert log
start the database (run restrict.brt)
check the Oracle alert log for errors
if any errors

write them to the brunner log

end if
close the log file
exit

Command Line Parameters

The following command line parameters are recognized by the brunner utility

/BACKUP

causes brunner to execute the backup.brt file to perform the backup procedure

/BACKUPSTOP

same as /BACKUP, except it causes brunner to update database statistics (by running doperf.sql) before performing the backup.

/MSG: msgText

displays a dialog box with the text, msgText.

/RESTRICT

starts the database in restricted mode

/SCHEDULE

schedules the automated backup using NT's AT scheduler service. (runs the schdback.cmd command file.)

/START

starts the database in normal mode

/STOP

stops the database using the immediate mode

NT Server—Registry Entries

When the Oracle sizing wizard is run by the client to create their database, a number of entries are written to the NT Server's system registry. The following entries are used by the brunner utility during execution

[HKEY_CURRENT_USER\Software\VB and
VBA Program Settings\PCPWOra\Log Files]
“Age”=“90”

This key controls how long messages are kept in the brunner.log file. This value is set during install and there is no method for changing this value with the exception of using the regedit program supplied as part of the NT Server Operating System.

[HKEY_CURRENT_USER\Software\VB and
VBA Program Settings\PCPWOra\Keys]
“PCPAYSYS”=“_=^{˜}ê_{—}^{˜}Uh”
“INTERNAL”=“Ü\dot{a} Y}_fÖ”
“MaintKey”=“_=^{˜}ê_{—}^{˜}Uh”
“MIGRATE”=“re_ëY=Á ”
“SUPEROP”=“_æÓ¦ _ ^{a}”
“REPORTS”=“,u⅜ y̅_\hat{ }•ƒ”
“Default”=“_=^{˜}ê_{—}^{˜}Uh”
“SYS”=“¹-_C_L(α”
“SYSTEM”=“í3TN a̅YIp”

These keys represent the user id's and passwords which can be part of a template (.brt) file. In order to use one of the user id/password combinations, the user id must be surrounded by %'s in the .brt file. For example, to use the SrvMgr23 utility to run a SQL file named dothis.sql and use the INTERNAL id and password, the following line would be in the dothis.brt file.

connect INTERNAL / %INTERNAL%
. . . some sql code here

At run time, brunner will retrieve the value for the INTERNAL key from the registry, decode the key value and write the following to the tempn.sql file in the c:\temp folder

connect INTERNAL / THEPASSWORD
. . . some sql code here
[HKEY_CURRENT_USER\Software\VB and
VBA Program Settings\PCPWOra\Files]
“Home”=“C:\\ORANT\\BIN”
“Maintenance”=“C:\\ORADATA\\PCPW\\admin\\maint”
“Admin”=“C:\\ORADATA\\PCPW\\ADMIN”
“Backup”=“ ”

These settings let brunner know where to find other files that it may need during execution

Chapter 1

hwb.exe

Health & Well-Being utility

Overview

The hwb utility is an unattended database diagnostic and auto-maintenance utility used by the client to perform the following database procedures
1. check the database for tablespace fragmentation
1. check the tablespaces for available free space
1. check the hard drives for available free space
1. fix any problems that can be fixed automatically without risk

There is no user intervention required during the execution of hwb. All process messages and errors are written to a log file named hwb.log. The user is instructed to check this log each morning following a scheduled run of hwb. By default, hwb is scheduled to run once a week, on Sunday mornings at 11:00 am. During the running of the Oracle sizing wizard (dbsizer) the user has the option to override this schedule.

Hwb's dialog box displays all the steps that it will perform during it's run. As each step is completed, a check mark will appear to the left of the step to signify it's completion. When all steps are complete, hwb will terminate automatically.

Psedo-Code

Following is pseudo-code for the hwb utility program.

get the language setting from the NT Server registry
center the dialog
retrieve / decode and store Oracle database user ids
and password from the registry
display the status dialog box
clear all the check marks next to each step
open the log file and note the start date and time
if not at least 1 MEG of free diskspace on the
\admin folder drive for scripts

write an error to the log file
exit

end if
shutdown the database (immediate mode)
restart the database in restricted mode
‘step 1 begins (analyze tables, gather information)
coalesce all tablespaces

run gencoal.sql which creates coalesce.sql
run coalesce.sql

build a list (no_fix.out) of tables with > 1 extent but are
too high risk to fix

generate no_fix.sql
run no_fix.sql (creates no_fix.out)

if no_fixout contains table names

write a message to the log file and tell the user which
tables need manual fixing

end if
run db_info.sql to generate report on database
internals (db_info.txt, not used but
handy)
analyze tables

generate bld_anal.sql
if we have not analyzed tables today (stored in the registry)

run bld_anal.sql which generates analyze.sql
run analyze.sql
store date in the registry so we don't do this again today

end if

if xtra.sql exists in the admin folder

execute it (this allows us to implement one time procedures)

end if
build a list of all tables that can be fixed (fix_tab.out)

generate fix_tab.sql
run fix_tab.sql, which generates a list of tables that hwb should fix

display a check mark next to step 1
‘step 1 complete
‘step 2 begins (check database performance)
run perf.sql, generates perf.out which is a table of current performance
for each line written to perf.out

lookup the performance criteria in the file perf.tbl
if found

compare database performance (perf.out) to error level (perf.tbl)
if above error level

write error to logfile

else

compare database performance (perf.out) to warning level

(perf.tbl)

if above warning level

write warning to logfile

end if

end if

end if

get next line from perf.out file
make sure there's at least 5 MEG on each hard drive used
to store PCPW data
if any drive does not have at least 5 MEG free

write message to log file

end if
display a check mark next to step 2
‘step 2 complete
‘step 3 fix low risk tables
‘each step is stringently checked for errors and logged to the hwb.log file
open the fix_tab.out file which list tables to fix
for each line in the fix_tab.out file

check each available drive to find one with enough
disk space to hold export file
if not

write error to logifile
skip this table, get the next line from fix_tab.out

end if
generate DDL script to rebuild primary key(s) (gen_pk.sql)
generate DDL script to rebuild foreign key(s) (gen_fk.sql)
export the data
drop the table
import the data from the export file
run gen_pk.sql to rebuild primary key(s)
run gen_fk.sql to rebuild foreign key(s)
cleanup and get ready for the next table

get next line from fix_tab.out
display a check mark next to step 3
‘step 3 complete
‘step 4 rebuild indexes (if necessary)
run fix_idx.sql which generates rbld_idx.sql
run rbld_idx.sql to rebuild indexes if necessary
display a check mark next to step 4
‘step 4 complete
cleanup any command files or script files left behind
note summary of warning and errors in the logfile (tally)
note completion date and time in the logfile
close the logfile
shutdown the database (immediate mode)
restart the database in normal mode
exit

Command Line Parameters

The following command line parameters are recognized by the hwb utility

/DEBUG

causes hwb to execute in debug mode. By default, hwb cleans up after itself deleting all temporary scripts and output files. When debugging, it is useful to look at these files so you can determine exactly what happened. CAUTION: this is extremely sensitive since SQL files and command files that contain the database password will be left on the hard drive in the \admin folder. Do not do this at a client site unless absolutely necessary, then when complete, re-run the hwb utility WITHOUT the /debug flag to clean up the admin folder sufficiently!

NT Server—Registry Entries

When the Oracle sizing wizard is run by the client to create their database, a number of entries are written to the NT Server's system registry. The following entries are used by the hwb utility during execution

[HKEY_CURRENT_USER\Software\VB and
VBA Program Settings\PCPWOra\Keys]
“PCPAYSYS”=“_=^{˜}ê_{—}^{˜}Uh”
“INTERNAL”=“Ü\dot{a} Y}_fÖ”
“MaintKey”=“_=^{˜}ê_{—}¹⁸Uh”
“MIGRATE”=“re_ëY=Á ”
“SUPEROP”=“_æÓ¦ _ ^{a}”
“REPORTS”=“,u⅜ y̅_\hat{ }•ƒ”
“Default”=“_=^{˜}ê_{—}¹⁸ Uh”
“SYS”=“¹-_C_L(α”
“SYSTEM”=“í3TNãYIp”

These keys represent the user id's and passwords which can be part of a template (.brt) file. In order to use one of the user id/password combinations, the user id must be surrounded by %'s in the .brt file. For example, to use the SrvMgr23 utility to run a SQL file named dothis.sql and use the INTERNAL id and password, the following line would be in the dothis.brt file.

connect INTERNAL / %INTERNAL%
. . . some sql code here

At run time, hwb will retrieve the value for the INTERNAL key from the registry, decode the key value and write the following to the tempn.sql file in the c:\temp folder

Connect INTERNAL / THEPASSWORD
. . . some sql code here
[HKEY_CURRENT_USER\Software\VB and
VBA Program Settings\PCPWOra\Files]
“Home”=“C:\\ORANT\\BIN”
“Maintenance”=“C:\\ORADATA\\PCPW\\admin\\maint”
“Admin”=“C:\\ORADATA\\PCPW\\ADMIN”
“Backup”=“ ”

These settings let hwb know where to find other files that it may need during execution

[HKEY_CURRENT_USER\Software\VB and
VBA Program Settings\PCPWOra\Extents]
“Number”=“1”

This settings tells hwb how many extents are acceptable. In this case, any tablespaces with more than 1 extent will be fixed.

[HKEY_CURRENT_USER\Software\VB and
VBA Program Settings\PCPWOra\HWB]
“Tables”=“1”
“Performance”=“0”
“Use Note of the Day”=“True”

These settings control some of the features of hwb. Tables tell hwb whether or not to check tablespaces during the database performance step. A 1 means Yes, a 0 means No. Performance tells hwb whether or not to check database engine performance criteria during the database performance step. Use Note of the Day. If “True” then fatal errors will generate a Note of the Day table entry. If “False” then fatal errors will only be logged to the hwb.log file. This is for client's who want to use the NT event log to monitor fatal errors. There is no way within the current version for hwb to write directly to the NT event log, but a client could write a program to analyze the hwb.log file and generate event entries. This is a good candidate for a PWR.

What is claimed is:

1. In a computer system, a method for building and sizing database tables comprising:
obtaining data requirement information;
performing a diagnosis on at least one database table;
obtaining a new size for said at least one database table using a result from said diagnosis and said data requirement information;
building said at least one database table; and
performing maintenance on said at least one database table.

2. The method of claim 1 wherein said obtaining said data requirement information further comprises obtaining user input.

3. The method of claim 2 wherein said obtaining said user input further comprises providing at least one user interface for obtaining said data requirement information.

4. The method of claim 1 wherein said obtaining said data requirement information further comprises obtaining network environment information.

5. The method of claim 1 wherein said obtaining said data requirement information further comprises obtaining information about storage devices available to support said at least one database table.

6. The method of claim 1 wherein said obtaining said data requirement information further comprises obtaining a backup method.

7. The method of claim 1 wherein said obtaining data requirement information further comprises obtaining a backup schedule.

8. The method of claim 1 wherein said obtaining data requirement information further comprises obtaining at least one requirement of at least one application.

9. The method of claim 1 wherein said performing a diagnosis on said at least one database table further comprises checking performance measures.

10. The method of claim 9 wherein said checking performance measures comprises generating a table of current performance.

11. The method of claim 9 wherein said checking performance measures comprises looking up performance criteria.

12. The method of claim 11 wherein said looking up performance criteria comprises checking an error level.

13. The method of claim 12 wherein said checking said error level comprises writing at least one error message to an error log.

14. The method of claim 9 wherein said checking performance measures comprises checking whether performance is above a warning level.

15. The method of claim 14 further comprising writing a warning message to a warning log when said performance is above said warning level.

16. The method of claim 9 wherein said checking said database performance further comprises determining a minimum space available for data.

17. The method of claim 1 wherein said performing said diagnosis on said at least one database table further comprises analyzing a plurality of objects contained in said at least one data base table.

18. The method of claim 17 wherein said analyzing said plurality of objects further comprises building a list of high-risk objects.

19. The method of claim 17 wherein said analyzing said plurality of objects further comprises building a list of objects that can be fixed.

20. The method of claim 1 wherein said performing said diagnosis on said at least one database table further comprises generating at least one report on internals of said at least one database table.
